(19) United States
(12) Patent Application Publication
(10) Pub. No.: US 2005/0152222 A1
(43) Pub. Date: Jul. 14, 2005

(54) Convex folded shell projector

(76) Inventors: Rick Kaufman, Ames, IA (US); Steven Saint-Vincent, Ames, IA (US); Richard A.G. Fleming, Dartmouth (CA); Christopher J. Purcell, Dartmouth (CA)

Correspondence Address: STITES & HARBISON PLLC, 1199 NORTH FAIRFAX STREET, SUITE 900, ALEXANDRIA, VA, 22314, US

(21) Appl. No.: 11/000,056

(22) Filed: Dec. 1, 2004

Related U.S. Application Data
(60) Provisional application No. 60/526,293, filed on Dec. 3, 2003.

(51) Int. Cl. H04R 17/00

(52) U.S. Cl. 367/163

(57) ABSTRACT

An acoustic projector comprising a pair of spaced apart end plates with an acoustic driver positioned between the end plates. The end plate's edges are secured to an outer one-piece thin walled shell that provides an enclosure for the driver. That thin walled shell has a convex outwardly bent surface between the end plates and a plurality of axially extending corrugations to provide a predetermined axial compliance and radial-to-axial transformation ratio.

This claims benefit of PROVISIONAL APPLICATION Ser. No. 60/526,293 filed on 3 Dec. 2003.

### FIELD OF THE INVENTION

The present invention relates to acoustic projectors and in particular to a flextensional projector that can be formed by blow molding.

### BACKGROUND OF THE INVENTION

U.S. Pat. No. 5,805,529 by Christopher Purcell (8 Sep. 1998) describes an acoustic projector, the Folded Shell Projector (FSP) for use underwater or in air, consisting of a corrugated cylinder with a generally concave hourglass-shaped cross section which operates according to the principles of flextensional projectors, where a motor causes a thin shell to move in a combination of flexural and extensional modes. The shell acts like a mechanical transformer, where a small motor displacement is transformed to a larger volume displacement of the surrounding fluid or gaseous medium. This efficiently couples a high force, low displacement motor to a compliant medium. The overall concave shape has the advantage that, at the breathing mode resonance of the shell, all radiating surfaces of the projector move in phase, resulting in omnidirectional radiation of sound, which is desirable for many applications. It also results in a hydrostatic load on the projector producing compressive load on the motor. Since most sonar motor materials are strong in compression and weak in tension, this loading configuration gives the concave FSP good depth capability. The FSP design completely encloses the motor in a hermetically sealed container, which protects the motor from flooding, corrosion or contamination. The FSP has been built in a number of variants, and of many materials (including metals, polymers and paper), for use underwater and in air. For in-air loudspeaker applications, the market is price sensitive. The shell of the FSP is a thin walled part of complex shape and high precision.

For low cost in-air applications, as a loudspeaker, it would be useful to make the shell from polymers, such as PETG, by blow molding. In this method, widely used for making beverage containers, an undersized hollow cylindrical polymer part (called in the trade, the preform) is inserted inside a multipart mold, and at a suitable temperature to allow plastic flow, the preform is inflated with high pressure gas forcing the polymer to conform to the mold. The mold is then separated and the formed part extracted. The concave shape of the folded shell projector described in U.S. Pat. No. 5,805,529 implies that the blow molding tooling must consist of many exterior sections, which must move radially outward for the polymer part to be extracted from the interior of the mold. The tooling for blow molding the concave folded shell projector will, as a result, be very costly to build, operate and maintain, because it will require many moving sections.

### SUMMARY OF THE INVENTION

It is a object of the present invention to provide a flextensional projector that can be manufactured from a polymer by blow molding at a low cost.

An acoustic projector according to the present invention comprises a pair of spaced apart end plates with an acoustic driver positioned between the end plates, edges of the end plates being secured to an outer one piece thin walled shell that provides an enclosure for said driver, the thin walled shell having a convexly outwardly bent surface and a plurality of axially extending corrugations to provide a predetermined axial compliance and radial-to-axial transformation ratio.

### BRIEF DESCRIPTION OF THE DRAWINGS

The invention will now be described in more detail with reference to the accompanying drawings, in which:

FIG. 1 is a perspective view of a known folded shell acoustic projector with one fold removed to illustrate its interior.

FIG. 2 is a perspective view of a known folded shell projector.

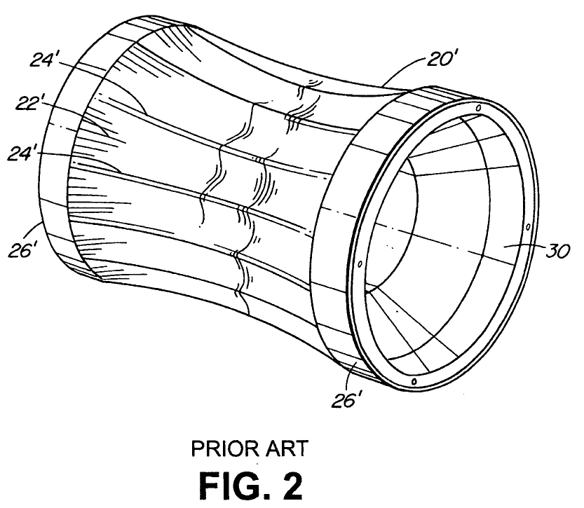

FIG. 3 is a perspective view of a folded shell projector according to the present invention.

### BRIEF DESCRIPTION OF A PREFERRED EMBODIMENT

U.S. Pat. No. 5,805,529 by Christopher Purcell (8 Sep. 1998) describes an acoustic projector, the Folded Shell Projector (FSP) for use underwater or in air, consisting of a corrugated cylinder with a generally concave hourglass-shaped cross section which operates according to the principles of flextensional projectors, where a motor causes a thin shell to move in a combination of flexural and extensional modes. The shell acts like a mechanical transformer, where a small motor displacement is transformed to a larger volume displacement of the surrounding fluid or gaseous medium. This efficiently couples a high force, low displacement motor to a compliant medium. The overall concave shape has the advantage that, at the breathing mode resonance of the shell, all radiating surfaces of the projector move in phase, resulting in omnidirectional radiation of sound, which is desirable for many applications. It also results in a hydrostatic load on the projector producing compressive load on the motor. Since most sonar motor materials are strong in compression and weak in tension, this loading configuration gives the concave FSP good depth capability. The FSP design completely encloses the motor in a hermetically sealed container, which protects the motor from flooding, corrosion or contamination. The FSP has been built in a number of variants, and of many materials (including metals, polymers and paper), for use underwater and in air. For in-air loudspeaker applications, the market is price sensitive. The shell of this known FSP is a thin walled part of complex shape and high precision. The key problem is how to manufacture the shell (for use in-air) from a polymer at low cost.

For low cost in-air applications, as a loudspeaker, it would be useful to make the shell from polymers, such as PETG, by blow molding. In this method, widely used for making beverage containers, an undersized hollow cylindrical polymer part (called in the trade, the preform) is inserted inside a multipart mold, and at a suitable temperature to allow plastic flow, the preform is inflated with high pressure gas forcing the polymer to conform to the mold. The mold is then separated and the formed part extracted. The concave shape of the folded shell projector described in U.S. Pat. No. 5,805,529 implies that the blow molding tooling must consist of many exterior sections, which must move radially outward for the polymer part to be extracted from the interior of the mold. The tooling for blow molded the concave folded shell projector will, as a result be very costly to build, operate and maintain.

The present invention is a variation on U.S. Pat. No. 5,805,529, which preserves a number of key advantages of the FSP, while providing for a substantial reduction in the cost of manufacture by blow molding.

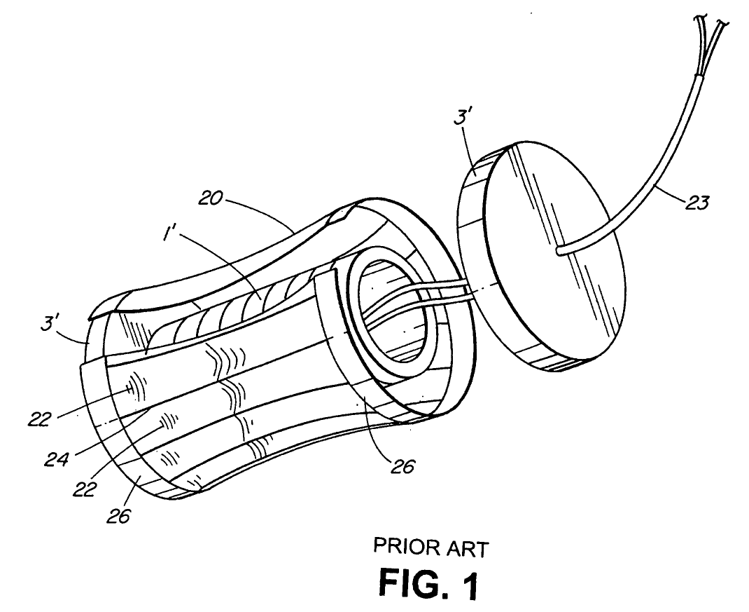

The basic concept of such a FSP described in U.S. Pat. No. 5,805,529 is illustrated in FIG. 1 with one fold removed to show the inner piezoelectric driver 1′. The thin-walled folded shell 20 is inwardly concavely shaped with a number of axially extending corrugations having valleys 22 and ridges or cusps 24. The corrugations extend between end flanges 26 which are intended to be connected to end caps 3′. Leads 23 extend from the piezoelectric driver 1′ through a central opening in one of the end caps 3′. Computer models of a slotless flextensional shell indicated that if aluminum (Al) was used as the shell material, then a wall thickness for practical designs would lie in the range of 1 to 2 mm and that approximately 16 folds (corrugations) would provide the required performance. The depth of the corrugations varies from a maximum at the center to 0 at the flange.

Low-cost high volume production of these thin-walled FSP shells would generally be done by stamping a thin walled shell from non-ferrous or ferrous metals such as aluminum or steel, or by molding or by casting in plastics or composites such as metal-matrix or fiber-reinforced plastics. There are many suitable metals or other materials from which a FSP may be manufactured with the best choices being ones that have lw internal acoustic damping, high stiffness, low density and which can be readily formed and machined. A low cost version of a FSP could be made using injected molded thermosetting fiber reinforced plastic but the acoustic damping of that material would reduce the efficiency of the projector. This may be an acceptable trade-off for some applications. Aluminum alloys have been used with great success in barrel stave projectors BSP and would be a suitable material for forming a FSP. A protective coating on a metal FSP may be required for projectors which are exposed directly to sea water for long periods of time. Those protective coatings could be in the form of an anodized layer, an electroplated layer, paint, etc.

The prototype FSP was provided with a piezoelectric acoustic motor but other types of drive motors could be employed in a FSP. A magnetostrictive drive motor, for instance, could be fitted into the space where the piezoelectric stack resided in the previously described prototype. Other types of acoustic drive motors that are suitable for use in FSPs include electrostrictive drive motors based on material such as PMN (lead metaniobate), electrodynamic drive motors (permanent magnet and coil) or hydroacoustic motors.

The previously described prototype FSP contained 16 axially extending corrugations. The number of corrugations could, however, be varied anywhere from 8 corrugations upward to obtain optimum performance when different materials, wall thickness and geometry are used to produce a folded shell. Various types of geometry would be suitable for these types of FSPs. The radius of curvature R of the inwardly concave surface of the shell upon which the folds are superimposed may be, for instance, 5 to 20 times the radius of the flange and the maximum fold depth may be anywhere from 2 to 10 times the thickness of the shell wall.

The previously described FSP had identical folds or corrugations in any one single shell. However, folds that are deeper than others with different curvatures can be formed in a single shell in order to optimize performance. These different folds could be alternated or one type of fold may be grouped on opposite sides.

The tooling for blow molding the concave folded shell projector will be very costly to build operate and maintain, because it will require many moving sections. If the folded shell projector's overall curvature were reversed, then the tooling could be made in only two parts with a parting line in the axial mid-plane of the shell. This will result in a small increase in directivity and possible loss of acoustic efficiency, arising from the fact that the projector will no longer be omnidirectional at the breathing mode resonance. This modest loss in acoustic performance will be more than offset by the reduction in price and particularly in price sensitive markets for the folded shell projector such as loud speakers.

The overall curvature of the known folded shell projector can be reversed, with only a minor effect on the directivity of the projector. A convex folded shell projector can be blow molded with a two part mold that will be cheaper to make and maintain than a mold for a concave folded shell.

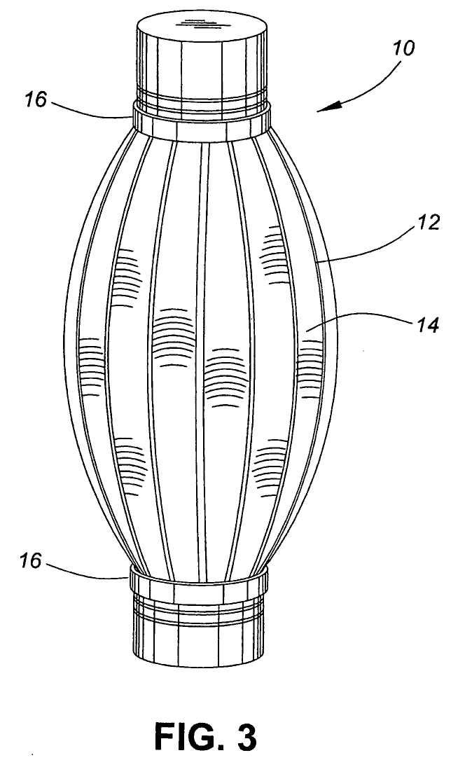

The convex folded shell projector 10 according to the present invention is illustrated in FIG. 3. It consists of a convex outwardly bent thin walled shell 12 containing axially extending corrugations 14 having rounded cusps with a flange 16 at each end. The flanges 16 at each end are secured to end plates (not shown). The drive motor may be selected from the group of electrodynamic driver motors electrostrictive drive motors, hydroacoustic motors and magnetostrictive driver motors. The thin walled shell 12 may have 8 or more axially extending corrugations 14 which have a maximum depths at a midpoint along a longitudinal axis of the shell with that depth varying axially so that it is 0 at flanges 16. The corrugations 14 may have a maximum fold depth of about 2 to 10 times the shell 12 wall's thickness.

Corrugations 14 or folds may not all be identical and some may be deeper than others with different curvatures formed in a single shell 12 in order to optimize performance. These different folds could be alternated or one type of fold may be grouped at one area of shell 12 and another type of fold at another area of shell 12.

The shell 12 can easily be manufactured by blow molding using a 2 part mold with a polymer such as Polyethyleneterephthalate Glycolate (PETG).

Various modifications may be made to the preferred embodiment without departing from the spirit and scope of the invention defined in the appended claims.

1. An acoustic projector comprising a pair of spaced apart end plates with an acoustic driver positioned between the end plates, the end plates having edges secured to an outer one-piece thin walled shell that provides an enclosure for said driver, the thin walled shell having a convex outwardly bent surface between the end plates And a plurality of axially extending corrugations to provide a predetermined axial compliance and radial-to-axial transformation ration.

2. An acoustic projector as defined in claim 1, wherein the thin walled shell is formed of a polymer.

3. An acoustic projector as defined in claim 2, wherein the polymer is PETG.

4. An acoustic projector as defined in claim 2, wherein the corrugations have a maximum fold depth of about 2 to 10 times the shell wall's thickness.

5. An underwater acoustic projector as defined in claim 4, wherein the corrugations have rounded cusps.

6. An acoustic projector as defined in claim 5, wherein the thin walled shell has a flange at each end which is secured to the end plates.

7. An acoustic projector as defined in claim 5, wherein the thin walled shell has at least 8 axial extending corrugations.

8. An acoustic projector as defined in claim 7, wherein the acoustic driver is selected from the group of electrodynamic driver motors, electrostrictive driver motors, hydroacoustic motors, and magnetostrictive driver motors.

9. An acoustic projector as defined in claim 7, wherein the corrugations have a maximum depth at a midpoint along a longitudinal axis of the shell, which depth varies axially and is 0 at said flange.

10. An acoustic projector as defined in claim 9, wherein some of the corrugations have different depths and curvatures than other corrugations in the shell.

11. An acoustic projector as defined in claim 3, wherein corrugations with at least two different maximum fold depths form said plurality of axially extending corrugations.
